(19) United States
(12) Patent Application Publication
(10) Pub. No.: US 2004/0239816 A1
(43) Pub. Date: Dec. 2, 2004

(54) Signal selection apparatus and signal selection method

(75) Inventor: Morio Ando, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/814,291

(22) Filed: Apr. 1, 2004

(30) Foreign Application Priority Data
May 29, 2003 (JP) 2003-153081

(51) Int. Cl. H04N 5/268

(52) U.S. Cl. 348/705; 348/554

(57) ABSTRACT

A signal selection apparatus according to one aspect of this invention comprises a plurality of digital signal input terminals, a signal processing unit having a video display unit and configured to process signals input from the plurality of digital signal input terminals and to output the processed signals to the video display unit, an input state detection unit configured to detect input states of signals to the plurality of digital signal input terminals, and a selection/supply unit configured to select, when the input state detection unit detects that signals are input to the plurality of digital signal input terminals, an input signal input to the digital signal input terminal, which is designated in advance, and supply the selected input signal to the signal processing unit.

### CROSS-REFERENCE TO RELATED APPLICATIONS

This application is based upon and claims the benefit of priority from prior Japanese Patent Application No. 2003-153081, filed May 29, 2003, the entire contents of which are incorporated herein by reference.

### BACKGROUND OF THE INVENTION

1. Field of the Invention

The present invention relates to a signal selection apparatus, which comprises a plurality of signal input terminals based on a digital interface, and selects and processes one of input signals, and a signal selection method.

2. Description of the Related Art

A currently prevalent TV broadcast-compatible receiver comprises, e.g., an input terminal for inputting an analog video signal. The receiver receives an analog video signal from an external apparatus via this input terminal, and outputs and displays a video based on this analog video signal.

Jpn. Pat. Appln. KOKAI Publication No. 9-128182 discloses a technique for recognizing a display by exchanging a control code between a display device and display adapter as a display system.

In recent years, as digital interface standards for next-generation televisions, the specification of a High-Definition Multimedia Interface (HDMI) has been released. However, the aforementioned TV broadcast-compatible receiver and display system do not assume equipment of the HDMI.

### BRIEF SUMMARY OF THE INVENTION

A signal selection apparatus according to one aspect of the invention comprises a plurality of digital signal input terminals, a signal processing unit having a video display unit and configured to process signals input from the plurality of digital signal input terminals and to output the processed signals to the video display unit, an input state detection unit configured to detect input states of signals to the plurality of digital signal input terminals, and a selection/supply unit configured to select, when the input state detection unit detects that a signal is input to only one of the plurality of digital signal input terminals, that input signal and supply the selected input signal to the signal processing unit, and to select, when the input state detection unit detects that signals are input to the plurality of digital signal input terminals, an input signal input to the digital signal input terminal, which is designated in advance, and supply the selected input signal to the signal processing unit.

A signal selection method according to one aspect of the invention for processing an input signal to one of a plurality of digital signal input terminals, and supplying the processed input signal to a video display unit, comprises preferentially designating a predetermined one of the plurality of digital signal input terminals in response to a user's designation, detecting input states of signals to the plurality of digital signal input terminals, and selecting, when it is detected that a signal is input to only one of the plurality of digital signal input terminals, a signal input to that digital signal input terminal, and selecting, when it is detected that signals are input to the plurality of digital signal input terminals, a signal input to the designated predetermined digital signal input terminal.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing an example of the arrangement of a video display apparatus to which a signal selection apparatus of the present invention is applied;

FIG. 2 is a schematic block diagram showing the arrangement of an HDMI signal processor; and

FIG. 3 is a flow chart showing an example of a signal selection process.

### DETAILED DESCRIPTION OF THE INVENTION

An embodiment of the present invention will be described hereinafter with reference to the accompanying drawings.

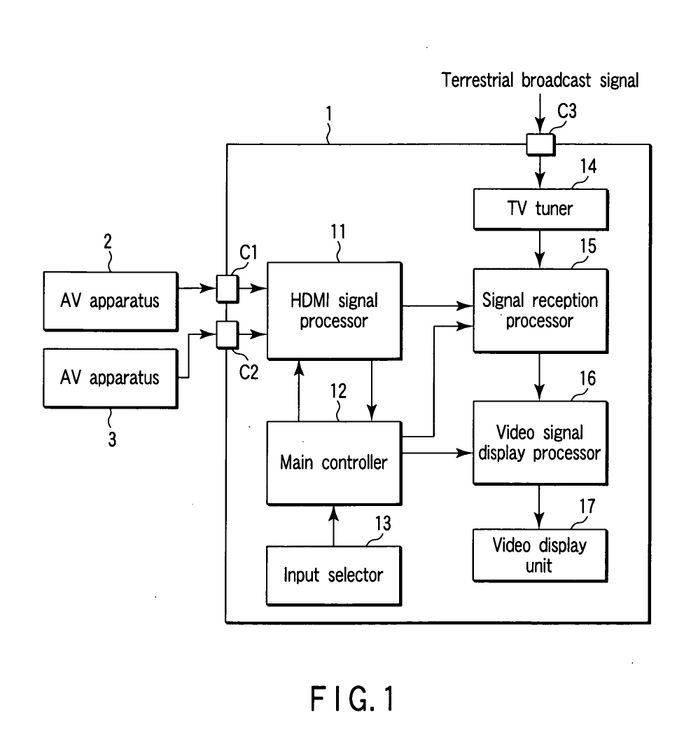

FIG. 1 is a schematic block diagram showing the arrangement of a video display apparatus to which a signal selection apparatus according to an embodiment of the present invention is applied. As shown in FIG. 1, a video display apparatus 1 comprises an HDMI signal processor 11, main controller 12, input selector 13, TV tuner 14, signal reception processor 15, video signal display processor 16, video display unit 17, and input terminals C1, C2, and C3.

The video display apparatus 1 comprises a plurality of signal input terminals based on a digital interface that complies with the HDMI standards. For example, the video display apparatus 1 which comprises two input terminals C1 and C2 complying with the HDMI standards will be explained. Furthermore, the video display apparatus 1 comprises an input terminal C3 that receives an analog signal of terrestrial broadcast.

The HDMI is an interface that has been standardized on the basis of a Digital Video Interface (DVI) adopted in, e.g., a PC display or the like. For example, the input terminal C1 receives a digital signal from an AV apparatus 2, and the input terminal C2 receives a digital signal from an AV apparatus 3. These AV apparatuses 2 and 3 correspond to, e.g., a DVD (Digital Versatile Disk) player, set-top box, and the like.

The HDMI signal processor 11 receives digital input signals input via the input terminals C1 and C2. When an input signal is supplied from one of the input terminals C1 and C2 to the HDMI signal processor 11, the HDMI signal processor 11 selects this supplied input signal under the control of the main controller 12, and applies a predetermined process to the selected input signal. When input signals are supplied from both the input terminals C1 and C2 to the HDMI signal processor 11, the HDMI signal processor 11 preferentially selects one of the two input signals under the control of the main controller 12, and applies a predetermined process to the selected input signal.

The input signal processed by the HDMI signal processor 11 is input to the signal reception processor 15. The signal reception processor 15 also receives an analog signal of terrestrial broadcast which is input from the input terminal C3 via the TV tuner 14. When only the input signal from the HDMI signal processor 11 is supplied to the signal reception processor 15, the signal reception processor 15 selects the signal from the HDMI signal processor 11 under the control of the main controller 12, and converts the selected signal into a video signal. On the other hand, when only the input signal from the TV tuner 14 is supplied to the signal reception processor 15, the signal reception processor 15 selects the signal from the TV tuner 14 under the control of the main controller 12, and converts the selected signal into a video signal.

Furthermore, when the input signals from both the HDMI signal processor 11 and TV tuner 14 are supplied to the signal reception processor 15, the signal reception processor 15 selects one of the two input signals under the control of the main controller 12, and converts the selected signal into a video signal. The converted video signal is input to the video signal display processor 16. The video signal display processor 16 converts the video signal into a display signal which is to be displayed on the video display unit 17 (display). The converted display signal is input to the video display unit 17, which displays an actual video on the basis of the display signal.

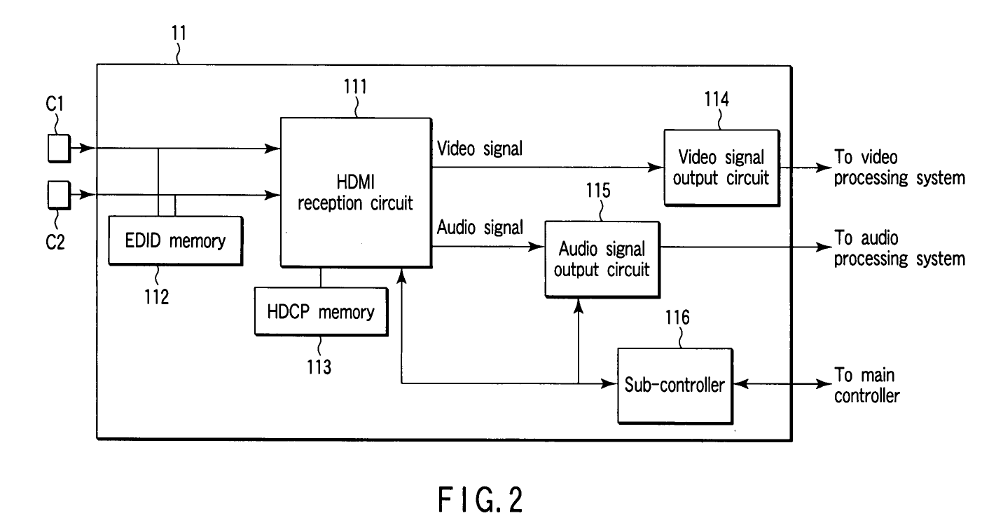

A schematic arrangement of the HDMI signal processor 11 will be described below with reference to FIG. 2. As shown in FIG. 2, the HDMI signal processor 11 comprises an HDMI reception circuit 111, EDID memory 112, HDCP memory 113, video signal output circuit 114, audio signal output circuit 115, and sub-controller 116. Note that the input terminals C1 and C2, and the HDMI reception circuit 111 are connected via a high-speed digital transmission path used to transmit video and audio signals and a communication control bus used to transmit control information.

The EDID memory 112 stores control information associated with, e.g., a display. “EDID” is an abbreviation for “Extended Display Identification Data”, and is data with which the display side (video display unit 17) makes the host side (AV apparatus 2 or 3) recognize information (resolution, the number of pixels, and the like) on the display side. The HDCP memory 113 stores key data that controls copy protection of a digital input signal, which is input via the input terminal C1 or C2. Note that “HDCP” is an abbreviation for “High Band Digital Content Protection”.

The HDMI reception circuit 111 receives digital input signals via the input terminals C1 and C2. The HDMI reception circuit 111 comprises, e.g., a D/A converter, which converts a digital video signal contained in the digital input signal input via the input terminal C1 or C2 into an analog video signal, and supplies the analog video signal to the video signal output circuit 14. Note that the HDMI reception circuit 111 need not always comprise a D/A converter. When the HDMI reception circuit 111 does not comprise any D/A converter, it supplies a digital video signal to the video signal output circuit 114. In this case, the video signal output circuit 114 comprises a D/A converter, which converts the digital video signal into an analog video signal and outputs the analog video signal. In this case, the output destination is a video processing system of the signal reception processor 15. Also, the HDMI reception circuit 111 supplies a digital audio signal contained in the digital input signal input via the input terminal C1 or C2 to the audio signal output circuit 115. The audio signal output circuit 115 comprises a D/A converter, which converts the digital audio signal into an analog audio signal, and outputs the analog audio signal. In this case, the output destination is an audio processing system of the signal reception processor 15.

The sub-controller 116 detects signal input states from the input terminals C1 and C2. That is, the sub-controller 116 detects whether or not signals are input from the input terminals C1 and C2. The sub-controller 116 communicates with the main controller 12, and selects input signals supplied from the input terminals C1 and C2 on the basis of the detection results of the signal input states and a signal selection instruction from the main controller 12.

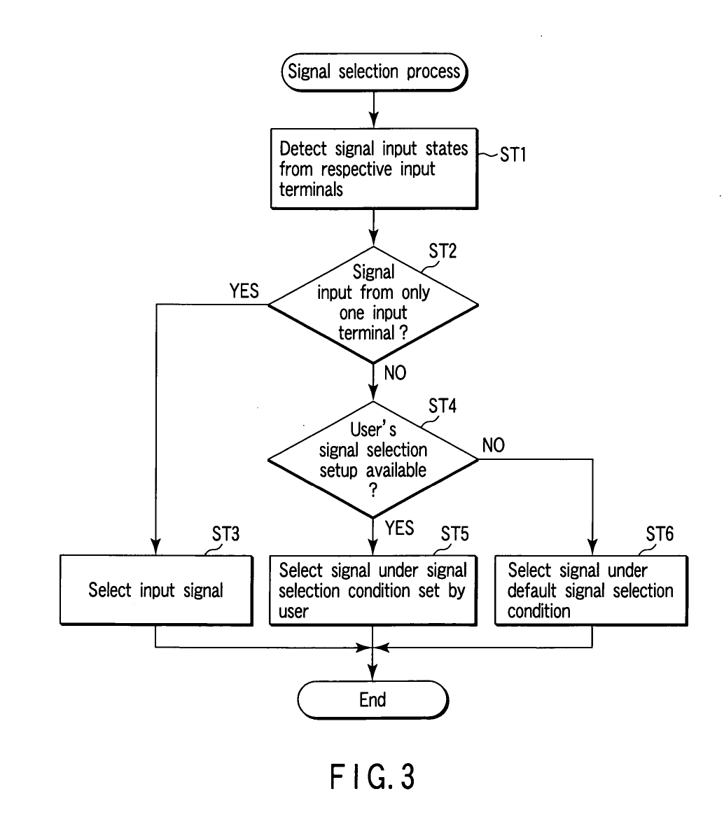

Details of the signal selection process will be explained below. FIG. 3 is a flow chart showing an overview of the signal selection process. The sub-controller 116 always monitors signal input states from the input terminals C1 and C2 (ST1). If the sub-controller 116 detects supply of an input signal from the input terminal C1 but does not detect supply of an input signal from the input terminal C2 (ST2, YES), it instructs to select a signal supplied from the input terminal C1. Base on this instruction, the HDMI reception circuit 111 selects the signal supplied from the input terminal C1 (ST3). Likewise, if the sub-controller 116 detects supply of an input signal from the input terminal C2 but does not detect supply of an input signal from the input terminal C1 (ST2, YES), it instructs to select a signal supplied from the input terminal C2. Base on this instruction, the HDMI reception circuit 111 selects the signal supplied from the input terminal C2 (ST3).

On the other hand, if the sub-controller 116 detects supply of input signals from both the input terminals C1 and C2 (ST2, NO), it instructs to select a signal supplied from one of the two terminals. If the user has made a signal selection setup (ST4, YES). The sub-controller 116 preferentially selects one of the input signals supplied from both the input terminals C1 and C2 on the basis of the user's signal selection setup (ST5). If the user does not make any signal selection setup (ST4, NO), the sub-controller 116 selects one (e.g., C1) of the input signals supplied from both the input terminals C1 and C2 on the basis of a default setup (ST6).

Next, the signal selection setup will be explained. The user can display a signal select information window on the video display unit 17 via a menu window display key, which is provided to a remote controller used to control various operations of the video display apparatus 1 or the main body (OSD function). This signal selection information window displays, e.g., information such as the current signal input states from the input terminals C1 and C2, the current signal selection state (default signal selection setup/user's signal selection setup), and the like. The sub-controller 116 detects the current signal input states from the input terminals C1 and C2, and notifies the main controller 12 of the detection results of the signal input states. The main controller 12 notifies the video signal display processor 16 of the detection results of the signal input states. The video signal display processor 16 displays the current signal input states from the input terminals C1 and C2 on the signal selection information window of the video display unit 17 on the basis of the detection results of the signal input states.

The sub-controller 116 manages a default signal selection setup/user's signal selection setup. The user can switch the input source using an input switch key provided to the remote controller or main body while observing the signal selection information window displayed on the video display unit 17. Since the signal selection information window displays information such as the current signal input states from the input terminals C1 and C2, the current signal selection state, and the like, the user can switch the input source while confirming these kinds of information. At this time, the sub-controller 116 may narrow down candidates to only the input source from which a signal is being currently input, and may make the user select that input source.

The input source switch instruction accepted by the input switch key provided to the remote controller or main body is sent to the input selector 13. The input selector 13 notifies the main controller 12 of the input source switch instruction. For example, if the user's signal selection setup is “not set”, information indicating that the user's signal selection setup is “not set” is supplied from the main controller 12 to the sub-controller 116. Upon reception of this information indicating that the user's signal selection setup is “not set”, the sub-controller 116 enables the default signal selection setup. For example, assume that the input terminal C1 is selected in the default signal selection setup. At this time, if input signals are supplied from both the input terminals C1 and C2, the sub-controller 116 instructs to select an input signal supplied from the input terminal C1. Based on this instruction, the HDMI reception circuit 111 selects an input signal supplied from the input terminal C1.

If the user's signal selection setup is “already set”, information indicating that the user's signal selection setup is “already set” is supplied from the main controller 12 to the sub-controller 116. Upon reception of this information indicating that the user's signal selection setup is “already set”, the sub-controller 116 disables the default signal selection setup. For example, assume that the input terminal C2 is selected in the user's signal selection setup. At this time, input signals are supplied from both the input terminals C1 and C2, the sub-controller 116 instructs to select an input signal supplied from the input terminal C2. Based on this instruction, the HDMI reception circuit 111 selects an input signal supplied from the input terminal C2.

The aforementioned information that pertains to the current signal selection setup state, i.e., “input terminal C1 active”, “input terminal C2 active”, or the like, can be confirmed on the signal selection information window. If an input signal from the input terminal C1 or C2 is being played back on the video display unit 17 in practice, information indicating that the input terminal C1 or C2 is selected is displayed on a given portion of a playback window of the video display unit 17. Furthermore, information indicating the selected one of the input terminals C1 and C2 may be provided by an LED or the like provided to the main body of the video display apparatus 1.

In the above description, selection of the input terminal C1 or C2 has been explained. However, the video display apparatus 1 also comprises the input terminal C3 in addition to the input terminals C1 and C2. Therefore, the video display apparatus 1 can execute a signal selection process having these three input terminals as selection candidates. In this case, the signal selection process is executed by both the HDMI signal processor 11 and signal reception processor 15. That is, the HDMI signal processor 11 executes a signal selection process for determining the input terminal C1 or C2 to be selected, and the signal reception processor 15 executes a signal selection process for determining the input terminal (C1 or C2) or C3.

In this way, the signal reception processor 15 receives one of a signal supplied from a digital apparatus and a signal of terrestrial broadcast, selects the input signal, and converts the selected signal into a video signal. At this time, the signal reception processor 15 adjusts video quality based on an input signal in accordance with the type of the input signal. That is, the processor 15 adjusts the brightness level, contrast level, and the like of a video based on a digital signal supplied from a digital apparatus in accordance with the characteristics of that digital signal. Likewise, the processor 15 adjusts the brightness level, contrast level, and the like of a video based on an analog signal of terrestrial broadcast in accordance with the characteristics of that analog signal. In this way, an optimal video according to the signal characteristics can be displayed on the video display unit 17.

As described above, since the video display apparatus according to the present invention comprises a plurality of input terminals complying with the HDMI standards, it can connect a plurality of apparatuses that output signals complying with the HDMI standards. Also, since the video display apparatus according to the present invention executes the aforementioned signal selection process, it can effectively select the connected apparatus. As a result, user's convenience can be improved in association with selection of connected apparatuses. Furthermore, since the video display apparatus according to the present invention can display information associated with selection of connected apparatuses, the user can adequately recognize information associated with current selection of the connected apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal selection apparatus comprising:
a plurality of digital signal input terminals;
a signal processing unit having a video display unit and configured to process signals input from the plurality of digital signal input terminals and to output the processed signals to the video display unit;
an input state detection unit configured to detect input states of signals to the plurality of digital signal input terminals; and
a selection/supply unit configured to select, when the input state detection unit detects that a signal is input to only one of the plurality of digital signal input terminals, that input signal and supply the selected input signal to the signal processing unit, and to select, when the input state detection unit detects that signals are input to the plurality of digital signal input terminals, an input signal input to the digital signal input terminal, which is designated in advance, and supply the selected input signal to the signal processing unit.

2. A signal selection apparatus comprising:
a plurality of digital signal input terminals;
a signal processing unit having a video display unit and configured to process signals input from the plurality of digital signal input terminals and to output the processed signals to the video display unit;
a designation unit configured to preferentially designate a predetermined one of the plurality of digital signal input terminals in response to a user's designation;
an input state detection unit configured to detect input states of signals to the plurality of digital signal input terminals; and
a selection/supply unit configured to select, when the input state detection unit detects that a signal is input to only one of the plurality of digital signal input terminals, that input signal and supply the selected input signal to the signal processing unit, and to select, when the input state detection unit detects that signals are input to the plurality of digital signal input terminals, a signal input to the predetermined digital signal input terminal, which is designated by the designation unit, and supply the selected input signal to the signal processing unit.

3. An apparatus according to claim 1, further comprising a display control unit configured to display information associated with the input states to the plurality of digital signal input terminals on the video display unit on the basis of detection of signal inputs to the plurality of digital signal input terminals by the input state detection unit.

4. An apparatus according to claim 2, further comprising a display control unit configured to display information associated with the input states to the plurality of digital signal input terminals on the video display unit on the basis of detection of signal inputs to the plurality of digital signal input terminals by the input state detection unit.

5. An apparatus according to claim l, further comprising a display control unit configured to display information associated with an input source of a signal selected by the selection/supply unit on the video display unit.

6. An apparatus according to claim 2, further comprising a display control unit configured to display information associated with an input source of a signal selected by the selection/supply unit on the video display unit.

7. An apparatus according to claim 1, wherein the signal processing unit includes an adjustment circuit which adjusts quality of a video reflected on a signal selected by the selection/supply unit in accordance with a type of the selected signal.

8. An apparatus according to claim 2, wherein the signal processing unit includes an adjustment circuit which adjusts quality of a video reflected on a signal selected by the selection/supply unit in accordance with a type of the selected signal.

9. An apparatus according to claim 1, further comprising an analog signal input terminal which inputs an analog signal, and
wherein the signal processing unit processes one of a signal selected by the selection/supply unit and a signal input to the analog signal input terminal, and includes an adjustment circuit which adjusts quality of a video reflected on the processed signal in accordance with a type of the processed signal.

10. An apparatus according to claim 2, further comprising an analog signal input terminal which inputs an analog signal, and
wherein the signal processing unit processes one of a signal selected by the selection/supply unit and a signal input to the analog signal input terminal, and includes an adjustment circuit which adjusts quality of a video reflected on the processed signal in accordance with a type of the processed signal.

11. A signal selection method for processing an input signal to one of a plurality of digital signal input terminals, and supplying the processed input signal to a video display unit, comprising:
detecting input states of signals to the plurality of digital signal input terminals; and
selecting, when it is detected that a signal is input to only one of the plurality of digital signal input terminals, a signal input to that digital signal input terminal, and selecting, when it is detected that signals are input to the plurality of digital signal input terminals, a signal input to the digital signal input terminal, which is designated in advance.

12. A signal selection method for processing an input signal to one of a plurality of digital signal input terminals, and supplying the processed input signal to a video display unit, comprising:
preferentially designating a predetermined one of the plurality of digital signal input terminals in response to a user's designation;
detecting input states of signals to the plurality of digital signal input terminals; and
selecting, when it is detected that a signal is input to only one of the plurality of digital signal input terminals, a signal input to that digital signal input terminal, and selecting, when it is detected that signals are input to the plurality of digital signal input terminals, a signal input to the designated predetermined digital signal input terminal.
